(19) United States
(12) Patent Application Publication
(10) Pub. No.: US 2019/0168757 A1
(43) Pub. Date: Jun. 6, 2019

(54) VEHICLE CONTROL DEVICE AND VEHICLE CONTROL METHOD

(71) Applicants: DENSO CORPORATION, Kariya-city, Aichi-pref. (JP); TOYOTA JIDOSHA KABUSHIKI KAISHA, Toyota-shi, Aichi-ken (JP)

(72) Inventors: Mitsuhiro TOKIMASA, Kariya-city, Aichi-pref (JP); Takuma SUDO, Kariya-city, Aichi-pref. (JP); Takashi MAEDA, Nagoya (JP)

(21) Appl. No.: 16/313,390

(22) PCT Filed: Jun. 15, 2017
(86) PCT No.: PCT/JP2017/022198

§ 371 Date: Dec. 26, 2018

(30) Foreign Application Priority Data
Jun. 27, 2016 (JP) 2016-127021

(51) Int. Cl. B60W 30/165; B60W 30/18

(52) U.S. Cl. CPC B60W 30/165; B60W 30/18163; B60W 2720/106; B60W 2540/20; B60W 2550/306

(57) ABSTRACT

When a turn signal of an own vehicle is operated when following a preceding vehicle, a vehicle control device performs a preceding vehicle following control to accelerate the own vehicle interlocking with the operation of the turn signal. The vehicle control device includes: an adjacent vehicle information acquisition unit that acquires adjacent vehicle information as information on an adjacent vehicle running in front of the own vehicle in an adjacent lane next to a running lane of the own vehicle; and an acceleration control unit that, when the turn signal of the own vehicle is operated, controls acceleration of the own vehicle based on the adjacent vehicle information.

### CROSS-REFERENCE TO RELATED APPLICATION

This patent application is based on Japanese Patent Application No. 2016-127021 filed on Jun. 27, 2016 in the Japan Patent Office, the entire disclosure of which is incorporated herein by reference.

### TECHNICAL FIELD

The present invention relates to a vehicle control device and a vehicle control method, more specifically, a vehicle control device that performs an acceleration control to accelerate the vehicle interlocking with an operation of a turn signal when the turn signal of the vehicle is operated, and a vehicle control method.

### BACKGROUND ART

As one of vehicle running assist controls, there is known a preceding vehicle following control under which, out of vehicles running in front of an own vehicle, a vehicle running in the path of the own vehicle is selected as a preceding vehicle and the own vehicle runs in such a manner as to follow the selected preceding vehicle (for example, refer to PTL 1). PTL 1 discloses that, when the turn signal of the own vehicle is operated during a preceding vehicle following control with respect to the preceding vehicle, the operation of the turn signal is regarded as the driver's indication of intention to pass the preceding vehicle, and then the own vehicle is accelerated. In the control device described in PTL 1, when the turn signal of the own vehicle is operated, the own vehicle is accelerated after a lapse of a predetermined time, and the predetermined time until the start of the acceleration is changed depending on the direction indicated by the turn signal so that the acceleration can be performed at an appropriate timing according to the condition of the road.

### CITATION LIST

### Patent Literature

[PTL 1] Japanese Patent No. 5045637

### SUMMARY OF THE INVENTION

When the driver operates the turn signal and tries to perform a lane change, accelerating the own vehicle interlocking with the operation of the turn signal might cause the need to stop the acceleration immediately afterward or decelerate the own vehicle depending on the conditions of the surroundings of the own vehicle. In such a case, the behavior of the vehicle is inconsistent with the driver's feelings and may cause the driver a feeling of strangeness.

The present disclosure has been devised in light of the foregoing problem. An object of the present disclosure is to provide a vehicle control device that allows an own vehicle to behave in accordance with driver's feelings when the own vehicle is accelerated interlocking with an operation of a turn signal.

To solve the foregoing issue, the present disclosure has adopted the following means:

A first aspect of the present disclosure relates to a vehicle control device that, when a turn signal of an own vehicle is operated during following of a preceding vehicle, performs a preceding vehicle following control to accelerate the own vehicle interlocking with the operation.

In the first aspect, the vehicle control device includes: an adjacent vehicle information acquisition unit that acquires adjacent vehicle information as information on an adjacent vehicle running in front of the own vehicle in an adjacent lane adjacent to a running lane of the own vehicle; and an acceleration control unit that, when the turn signal of the own vehicle is operated, controls acceleration of the own vehicle based on the adjacent vehicle information.

Depending on the presence or absence of an adjacent vehicle in front of the own vehicle or the running condition of the adjacent vehicle, accelerating the own vehicle along with the operation of the turn signal of the own vehicle might cause the need to decelerate the own vehicle immediately after the acceleration. In light of the foregoing points, when the turn signal of the own vehicle is operated, the acceleration of the own vehicle is controlled based on the information on the adjacent vehicle in front of the own vehicle. According to this configuration, the acceleration of the own vehicle during a lane change can be controlled depending on the condition of the adjacent vehicle to suppress an unnatural behavior such as deceleration immediately after the acceleration from occurring. As a result, the vehicle can behave in accordance with the driver's feelings.

A second aspect of the present disclosure relates to a vehicle control device that, when a turn signal of an own vehicle is operated when following a preceding vehicle, performs a preceding vehicle following control to accelerate the own vehicle interlocking with the operation. In the second aspect, the vehicle control device includes: a lane change determination unit that determines whether a lane change from a running lane of the own vehicle to an adjacent lane adjacent to the running lane is permitted; and an acceleration control unit that, when it is determined that the lane change is permitted by the lane change determination unit, accelerates the own vehicle under the preceding vehicle following control, and when it is not determined that the lane change is permitted by the lane change determination unit, does not accelerate the own vehicle under the preceding vehicle following control.

When the lane change from the running lane of the own vehicle to the adjacent lane is not permitted, accelerating the own vehicle along with the operation of the turn signal of the own vehicle might cause the need to stop the acceleration immediately afterward or decelerate the own vehicle. In light of this, when the turn signal of the own vehicle is operated, the acceleration of the own vehicle is controlled depending on the result of the determination on whether the lane change to the adjacent lane is permitted. According to this configuration, the acceleration of the own vehicle during a lane change can be controlled depending on whether the lane change to the adjacent lane is permitted, thereby suppressing unnatural behavior such as stopping the acceleration immediately afterward or decelerating the own vehicle. As a result, the vehicle can behave in accordance with the driver's feelings.

### BRIEF DESCRIPTION OF THE DRAWINGS

The foregoing and other objects, features, and advantages of the present disclosure will be more clarified by the following detailed descriptions with reference to the accompanying drawings. The drawings are as follows:

FIG. 1 is a block diagram of a schematic configuration of a vehicle control system;

FIG. 2 is a diagram illustrating scenarios with a presence or absence of a preceding vehicle and an adjacent vehicle during an operation of a turn signal;

FIG. 3 is a diagram illustrating correspondences among the presence or absence of the preceding vehicle, the presence or absence of the adjacent vehicle and the relative velocity of the adjacent vehicle to the own vehicle, and the behavior of the own vehicle when a turn signal of the own vehicle is switched on;

FIG. 4 is a diagram describing an acceleration suppression range;

FIG. 5 is a diagram illustrating the relationships among a relative speed W, a distance lower limit value DL, and a distance upper limit value DH;

FIG. 6 is a flowchart of a procedure for a turn-signal interlocking control;

FIG. 7 is a flowchart of a procedure for a first interlocking control;

FIG. 8 is a flowchart of a procedure for a second interlocking control; and

FIG. 9 is a flowchart of a procedure for a turn-signal interlocking control in a second embodiment.

### DESCRIPTION OF EMBODIMENTS

### First Embodiment

A first embodiment of a vehicle control device will be described with reference to the drawings. In the following embodiments, identical or equivalent components will be given the same reference signs in the drawings and descriptions of the components with the same reference signs are incorporated by reference.

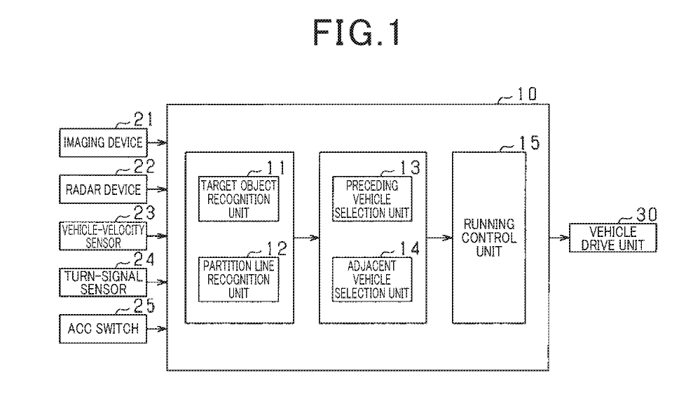

The vehicle control device of the present embodiment is installed in a vehicle. The vehicle control device has an adaptive cruise control (ACC) function and performs a preceding vehicle following control to follow a preceding vehicle running in front of an own vehicle in a path of the own vehicle. First, a schematic configuration of this system will be described with reference to FIG. 1.

Referring to FIG. 1, a vehicle control device 10 is a computer including a CPU, a ROM, a RAM, an I/O, and others. The CPU executes programs installed in the ROM to implement various functions. The ROM is equivalent to a computer-readable recording medium that functions as a non-transitory tangible recording medium. The vehicle (own vehicle) has an imaging device 21 and a radar device 22 as object detection devices that detect objects existing around the vehicle. The vehicle control device 10 accepts inputs of object detection information from the object detection devices and executes a preceding vehicle following control with respect to the preceding vehicle based on the inputted detection information.

The imaging device 21 is an in-vehicle camera that is composed of a CCD camera, a CMOS image sensor, a near-infrared camera, or the like. The imaging device 21 acquires images of a surrounding environment including the running road of the own vehicle, generates image data indicating the acquired images, and outputs the same in sequence to the vehicle control device 10. The imaging device 21 is attached to a widthwise center of the vehicle at a predetermined height to acquire the images of a region spreading forward from the vehicle at a birds'-eye angle in a predetermined acquiring angle range.

The radar device 22 is a detection device that transmits an electromagnetic wave as a transmission wave and receives a reflection wave to detect an object. In the present embodiment, the radar device 22 is a millimeter-wave radar. The radar device 22 is attached to the front part of the own vehicle to scan with a radar signal a region spreading forward from the vehicle centered on an optical axis in a predetermined angle range. The radar device 22 creates distance measurement data based on the time from the transmission of the electromagnetic wave in a direction forward from the vehicle to the reception of the reflection wave, and outputs the created distance measurement data in sequence to the vehicle control device 10. The distance measurement data includes information on the orientation where an object exists, the distance to the object, and the relative velocity.

The vehicle control device 10 accepts inputs of the image data from the imaging device 21 and the distance measurement data from the radar device 22, and accepts inputs of detection signals from various sensors and switches provided in the vehicle. The various sensors and switches include a vehicle velocity sensor 23 that detects the vehicle velocity, a turn-signal sensor 24 that detects the position of the turn signal (turn signal) of the own vehicle among right-turn specifying position, left-turn specifying position, or non-operated position, and outputs the detection signal, and an ACC switch 25 that is an input switch for the driver to select execution or non-execution of a preceding vehicle following control mode, and others.

When the ACC switch 25 is turned on, the vehicle control device 10 performs an acceleration/deceleration control such that, when there is a preceding vehicle, the own vehicle follows the preceding vehicle at a vehicle velocity set by the driver as an upper limit or a lower velocity at a constant distance between the own vehicle and the preceding vehicle. Specifically, the vehicle control device 10 sets a target acceleration rate such that the distance between the own vehicle and the preceding vehicle approaches a target inter-vehicle distance set by the driver, and controls the acceleration rate of the own vehicle based on the set target acceleration rate. On the other hand, when there is no preceding vehicle, the vehicle control device 10 performs a control to keep the velocity of the own vehicle constant to meet the vehicle velocity set by the driver, the speed limit on the road, or the like. Instead of the target inter-vehicle distance, a target inter-vehicle time as a value obtained by dividing the target inter-vehicle distance by the velocity of the own vehicle may be used.

When the turn signal of the own vehicle is changed from the non-operated position to the right-turn specifying position or left-turn specifying position when following the preceding vehicle, the vehicle control device 10 in this system accelerates the own vehicle interlocking with the operation of the turn signal from the stage prior to the completion of the own vehicle's lane change (for example, before the start of the own vehicle's lane change) for a predetermined time (for example, the time determined based on the time necessary for the lane change). Accordingly, when the driver operates the turn signal to perform a lane change, the acceleration is started little ahead of time so that the operations from making a lane change to passing the preceding vehicle can be smoothly performed. At this time, the own vehicle is accelerated at the vehicle velocity set by the driver or lower.

In a situation where a vehicle exists in front of the own vehicle and in an adjacent lane adjacent to the lane in which the own vehicle is running, even when the own vehicle is accelerated interlocking with the operation of the turn signal of the own vehicle, the own vehicle may need to be decelerated immediately afterward. In such a case, there is a concern that the vehicle will become deteriorated in running comfort.

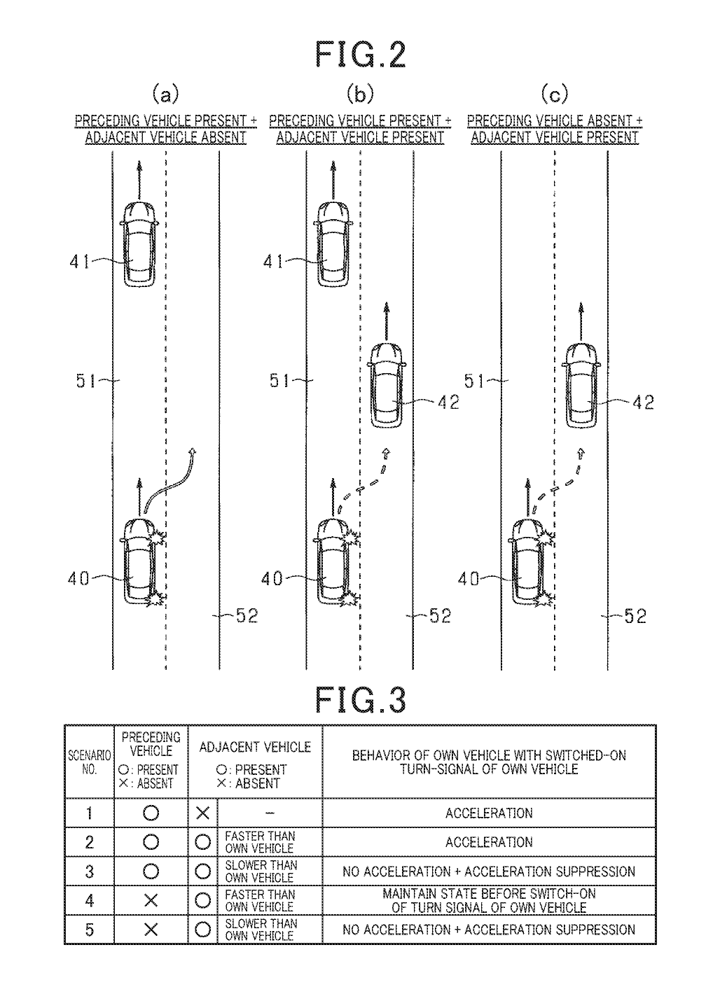

Specifically, as illustrated in FIG. 2(a), in a situation where no adjacent vehicle is running in an adjacent lane 52 as a lane right next to an own vehicle lane 51 in front of an own vehicle 40, there is no obstacle to acceleration of the own vehicle in the path of the own vehicle. Accordingly, accelerating the own vehicle 40 interlocking with the operation of the turn signal allows the own vehicle 40 to pass a preceding vehicle 41 smoothly. In contrast to this, as illustrated in FIG. 2(b), in a situation where an adjacent vehicle 42 is running, when the own vehicle 40 is accelerated interlocking with the operation of the turn signal, the own vehicle 40 after the lane change may become too close to the adjacent vehicle 42 before the lane change. In such a case, it is necessary to decelerate the own vehicle 40 immediately after the acceleration. As illustrated in FIG. 2(c), the same matter is applied to the case where the driver switches on the turn signal to perform a lane change when the own vehicle 40 is not following the preceding vehicle.

Accordingly, in the present embodiment, information on the adjacent vehicle 42 running in the adjacent lane 52 in front of the own vehicle 40 (hereinafter, called adjacent vehicle information) is acquired, and when the turn signal of the own vehicle 40 is switched from off to on during running of the vehicle, the acceleration of the own vehicle 40 is controlled interlocking with the operation of the turn signal of the own vehicle 40 based on the adjacent vehicle information.

Specifically, as illustrated in FIG. 1, the vehicle control device 10 includes a target object recognition unit 11, a partition line recognition unit 12, a preceding vehicle selection unit 13, an adjacent vehicle selection unit 14, and a running control unit 15. The target object recognition unit 11 recognizes an object existing around the own vehicle 40 based on the image data acquired from the imaging device 21 and the distance measurement data acquired from the radar device 22. Specifically, the target object recognition unit 11 detects the position of the target object based on the distance measurement data, and recognizes the type of the target object and the position of the target object in the image based on the image data. In addition, when the position based on the distance measurement data and the position based on the image data are in proximity to each other, the target object recognition unit 11 regards these positions as belonging to the same object and associates the data with each other, and fuses the data to acquire positional information of the object. Further, the target object recognition unit 11 performs pattern matching on the target object in the image by using predetermined patterns to identify the type of the object acquired by the imaging device 21, for example, among a vehicle, pedestrian, or bicycle.

The partition line recognition unit 12 recognizes partition lines on the road such as white lines. Specifically, the partition line recognition unit 12 inputs image data from the imaging device 21, and extracts edge points as candidates for partition lines from the image data based on the rate of luminance change or the like in the horizontal direction of the image. The partition line recognition unit 12 also subjects the extracted edge points to Hough transform to connect feature points and recognize the shapes of the partition lines. The partition line recognition unit 12 stores the recognized shapes of the partition lines as partition line information.

The preceding vehicle selection unit 13 accepts inputs of the target object information from the target object recognition unit 11 and the partition line information from the partition line recognition unit 12, and selects the preceding vehicle 41 by using the inputted information. The preceding vehicle 41 is a vehicle running in the path of the own vehicle 40. The preceding vehicle selection unit 13 selects the preceding vehicle 41 in such a manner as to, when the partition lines have been recognized, for example, recognize the lane in which the own vehicle 40 is running (that is, the own vehicle lane 51) from the partition lines, and regard the vehicle running in front of the own vehicle 40 in the own vehicle lane 51 as the preceding vehicle. When no partition lines have been recognized, the preceding vehicle selection unit 13 identifies the preceding vehicle from the movement track of the vehicle in front. The preceding vehicle selection unit 13 also performs an arithmetic operation on preceding vehicle information as information on the preceding vehicle. The preceding vehicle information includes the presence or absence of the preceding vehicle, the target object number for the preceding vehicle, the relative distance of the preceding vehicle to the own vehicle, the relative velocity of the preceding vehicle to the own vehicle, and others.

The adjacent vehicle selection unit 14 selects the adjacent vehicle 42 from other vehicles existing in front of the own vehicle 40. In the present embodiment, the adjacent vehicle selection unit 14 selects the adjacent vehicle 42 from other vehicles in front of the own vehicle 40, based on the lateral position as position relative to the own vehicle 40 which is in a direction orthogonal to the traveling direction of the own vehicle 40 and the relative distance to the own vehicle 40 which is in the traveling direction of the own vehicle 40.

Specifically, the adjacent vehicle selection unit 14 accepts an input of the target object information from the target object recognition unit 11, and extracts adjacent vehicle candidates from the vehicles existing in front of the own vehicle 40, vehicles that are located at relative distances equal to or shorter than a predetermined distance Lth within an adjacent vehicle selection range as a lateral position range for determination of the adjacent vehicle 42. The adjacent vehicle selection unit 14 also selects an adjacent vehicle from the extracted adjacent vehicle candidates, a vehicle that is located at the minimum relative distance to the own vehicle 40 detected by the radar device 22 and is not a preceding vehicle. The adjacent vehicle selection unit 14 selects a right adjacent vehicle running in the lane on the right side of the own vehicle and a left adjacent vehicle running in the lane on the left side of the own vehicle.

Further, the adjacent vehicle selection unit 14 also performs an arithmetic operation on adjacent vehicle information. The adjacent vehicle information includes the presence or absence of an adjacent vehicle, the target object number for the adjacent vehicle, a relative distance D of the adjacent vehicle to the own vehicle, and a relative velocity W of the adjacent vehicle to the own vehicle, and others. The adjacent vehicle selection unit 14 functions as adjacent vehicle information acquisition unit.

The running control unit 15 calculates a control instructive value for implementing various controls for driving assistance and outputs the calculated results to a vehicle drive unit 30. The vehicle drive unit 30 is a means for driving and braking the vehicle and is composed of an engine fuel injection valve, an ignition device, a throttle valve, a braking device, and others, for example. The various controls for driving assistance include, for example, a preceding vehicle following control with respect to a preceding vehicle by the ACC function, a running control for issuing a warning to the driver during a lane change of the own vehicle or restricting a lane change by a lane change support (LCS) function, a collision avoidance control for operating the brakes and others when the distance to a preceding vehicle becomes short or reducing the damage of a collision, and others.

Hereinafter, a turn-signal interlocking control executed by the running control unit 15 will be described in more details. In the turn-signal interlocking control, when the turn signal of the own vehicle 40 is switched from off to on, the acceleration state of the own vehicle 40 after the operation of the turn signal is controlled according to the presence or absence of a preceding vehicle, the presence or absence of an adjacent vehicle, and the relative velocity of the adjacent vehicle to the own vehicle during the operation of the turn signal. The running control unit 15 functions as an acceleration control unit.

FIG. 3 is a table illustrating the correspondences among the presence or absence of a preceding vehicle, the presence or absence of an adjacent vehicle and the relative velocity of the adjacent vehicle to the own vehicle, and the behavior of the own vehicle at the switch-on of the turn signal of the own vehicle. In a case of the presence of a preceding vehicle and the absence of an adjacent vehicle (scenario 1) and in a case of the presence of a preceding vehicle and the absence of an adjacent vehicle and in which the adjacent vehicle is running faster than the own vehicle (scenario 2), the own vehicle 40 is accelerated quickly after the operation of the turn signal. When the own vehicle is being accelerated, the acceleration is maintained. This is because, in a scenario in which, after a lane change, the own vehicle 40 follows an adjacent vehicle higher in velocity than the own vehicle 40, even when the own vehicle 40 is accelerated interlocking with the operation of the turn signal, the own vehicle 40 will not be decelerated immediately after the acceleration. In addition, accelerating the own vehicle 40 makes it possible to, when the adjacent vehicle before the lane change becomes the next preceding vehicle, allow the own vehicle 40 to follow the preceding vehicle in a smooth manner.

In contrast to this, in a case of the presence of a preceding vehicle and the presence of an adjacent vehicle and in which the adjacent vehicle 42 is running slower than the own vehicle 40 (scenario 3), accelerating the own vehicle 40 interlocking with the operation of the turn signal of the own vehicle 40 could cause the own vehicle 40 to decelerate immediately after the lane change. Therefore, in such a scenario, even when the turn signal of the own vehicle 40 is switched from off to on, the own vehicle 40 is not accelerated interlocking with the operation of the turn signal. In addition, when the own vehicle 40 is being accelerated, the own vehicle 40 is suppressed from accelerating. Specifically, when the own vehicle 40 is being accelerated before the operation of the turn signal, the acceleration rate is changed from the positive value to zero. When the own vehicle 40 is running at a constant velocity before the operation of the turn signal, the velocity of the vehicle during the constant-velocity running is maintained, and when the own vehicle 40 is being decelerated, the deceleration state is maintained.

In the present specification, the acceleration rate of the own vehicle 40 being accelerated forward is expressed as positive and the acceleration rate of the own vehicle 40 being decelerated is expressed as negative. The relative velocity of another vehicle to the own vehicle 40 is expressed as positive when the other vehicle is running faster than the own vehicle 40, and is expressed as negative when the other vehicle is running slower than the own vehicle 40.

In the case in the absence of a precedence vehicle, the own vehicle 40 is not accelerated interlocking with the operation of the turn signal of the own vehicle 40. However, when the adjacent vehicle 42 exists in front of the own vehicle in the direction in which the own vehicle 40 will perform a lane change, the acceleration state of the own vehicle 40 is controlled according to the relative speed W of the adjacent vehicle 42 to the own vehicle 40. Specifically, when the adjacent vehicle 42 is running faster than the own vehicle 40 (scenario 4), the running state before the switch-on of the turn signal of the own vehicle 40 is maintained. Therefore, while the own vehicle 40 is running at a constant velocity before the operation of the turn signal, the velocity of the vehicle during the constant-speed running is maintained, and when the own vehicle 40 is being accelerated, the acceleration rate at that time is maintained. When the own vehicle 40 is being decelerated, the deceleration rate at that time is maintained.

In contrast to this, when the adjacent vehicle 42 is running slower than the own vehicle 40 during the operation of the turn signal of the own vehicle 40 (scenario 5), the own vehicle 40 is not accelerated interlocking with the operation of the turn signal of the own vehicle 40, and when the own vehicle 40 is being accelerated, the acceleration of the own vehicle 40 is maintained. Therefore, when the own vehicle 40 is running at a constant velocity before the operation of the turn signal, the velocity of the vehicle during the constant-velocity running is maintained, and when the own vehicle 40 is being decelerated, the deceleration rate at that time is maintained. In addition, when the own vehicle 40 is being accelerated before the operation of the turn signal, the acceleration rate is changed from the positive value to zero. Accordingly, the own vehicle 40 is suppressed from accelerating.

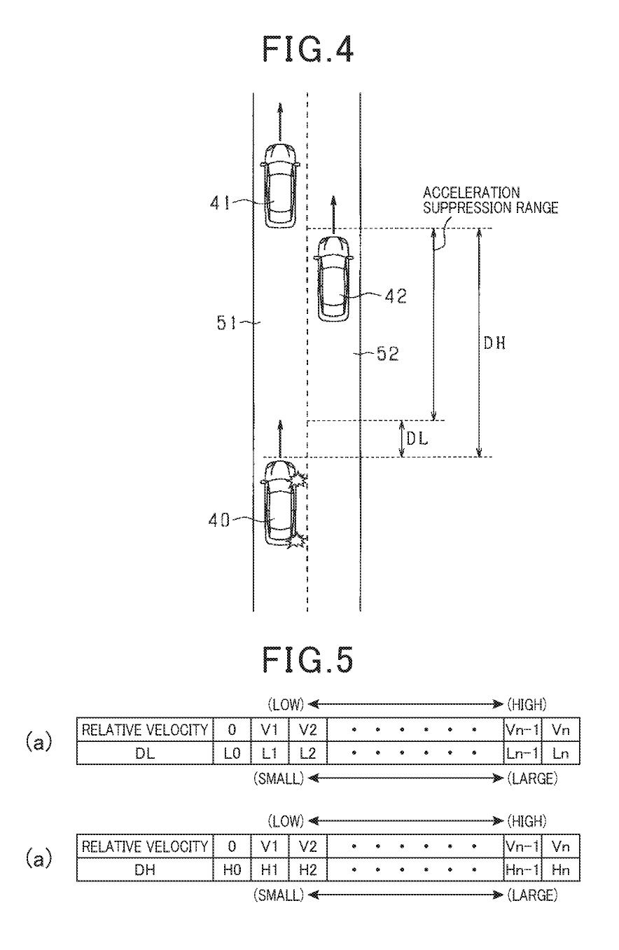

However, even in the scenario 3 or the scenario 5 illustrated in FIG. 3, it may not be necessary for suppression of acceleration interlocking with the operation of the turn signal of the own vehicle 40 or it may be preferred not to perform the suppression of acceleration, depending on the relative distance D of the adjacent vehicle 42 to the own vehicle 40. Specifically, referring to FIG. 4, in a case where the adjacent vehicle 42 is distant from the own vehicle 40, even when the acceleration of the own vehicle 40 before the operation of the turn signal is maintained, it is possible to keep the sufficient inter-vehicle distance to the adjacent vehicle 42 after the lane change. In addition, in a case where the adjacent vehicle 42 exists at a short distance from the own vehicle 40, even when the own vehicle 40 is suppressed from accelerating, the own vehicle 40 may cut into a close range behind the adjacent vehicle 42.

In light of this respect, in the present embodiment, in the case where the turn signal of the own vehicle 40 is operated during acceleration of the own vehicle 40, when the adjacent vehicle 42 exists in front of the own vehicle 40 during the operation and the adjacent vehicle 42 is running slower than the own vehicle 40, the acceleration of the own vehicle 40 is controlled depending on the relative distance D of the adjacent vehicle 42 to the own vehicle 40. Specifically, when the relative distance D is within a range that is larger than a distance lower limit value DL and smaller than a distance upper limit value DH (hereinafter, called acceleration suppression range), the acceleration of the own vehicle 40 is suppressed from being accelerated. On the other hand, in the case where the relative distance D is equal to or less than the distance lower limit value DL and equal to or larger than the distance upper limit value DH, when the own vehicle 40 is being accelerated, the acceleration state is maintained.

In the present embodiment, the distance lower limit value DL and the distance upper limit value DH are set according to the relative speed W of the adjacent vehicle 42 to the own vehicle 40. Specifically, as illustrated in FIG. 5(a), the distance lower limit value DL is set to be smaller as the relative velocity W is lower. As illustrated in FIG. 5(b), the distance upper limit value DH is set to be smaller as the relative velocity W is lower. In addition, the distance upper limit value DH and the distance lower limit value DL are set such that the acceleration suppression range becomes wider as the relative velocity W is lower.

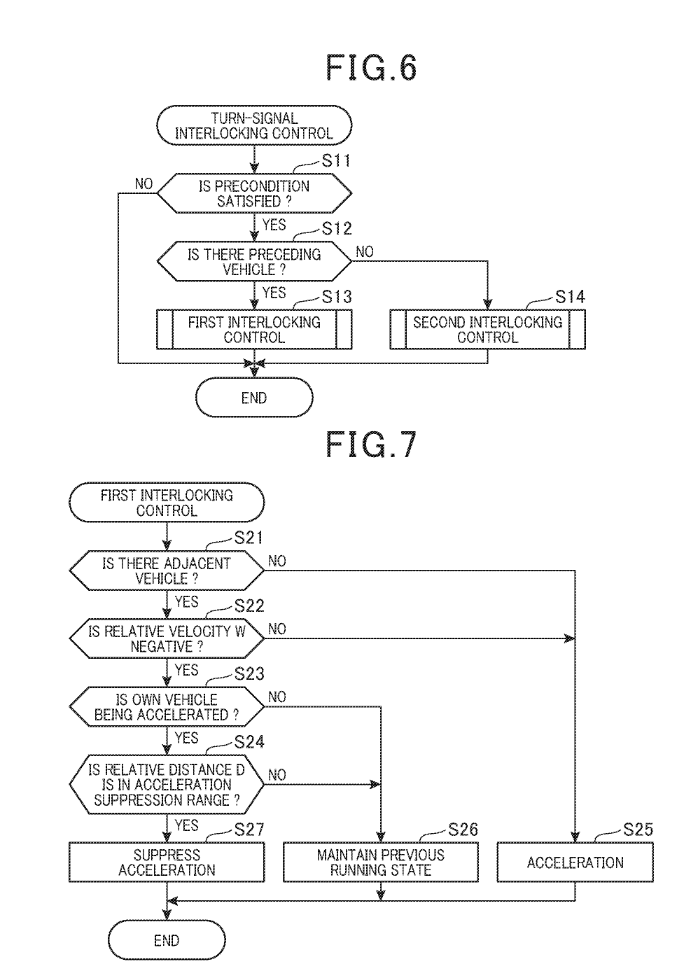

Next, a procedure for a turn-signal interlocking control in the present embodiment will be described with reference to the flowcharts of FIGS. 6 to 8. The turn-signal interlocking control described in FIG. 6 is executed by the vehicle control device 10 that has accepted an input of a detection signal indicating the switching from off to on of the turn signal during the running of the own vehicle 40.

Referring to FIG. 6, it is determined in step S11 that whether preconditions for performing the turn-signal interlocking control are satisfied. In the present embodiment, the preconditions include that the velocity of the own vehicle 40 detected by the vehicle velocity sensor 23 is equal to or higher than a threshold Vth (for example, 70 to 80 km/h or more) and that a lane change from the own vehicle lane 51 to the adjacent lane 52 is permitted by the LCS function.

Here, whether a lane change from the own vehicle lane 51 to the adjacent lane 52 is permitted by the LCS function is determined depending on whether an LCS permission flag is off that indicates non-permission of a lane change or on that indicates permission of a lane change. The LCS permission flag is set based on the surrounding environment including the areas in front of and behind the own vehicle 40. Specifically, the LCS permission flag is tuned off to prohibit the lane change from the own vehicle lane 51 to the adjacent lane 52 when at least any of predetermined lane change prohibition conditions is satisfied, including that the presence of an obstacle likely to collide with the own vehicle 40 in front of, side of, or behind the own vehicle 40 is recognized in the adjacent lane 52 next to the own vehicle 40, that the velocity of a vehicle running behind the own vehicle 40 and approaching the own vehicle 40 is equal to or higher than a predetermined velocity, that the partition lines can be no longer recognized from the image, and others. On the other hand, when none of the lane change prohibition conditions is satisfied, the LCS permission flag is turned on to permit the lane change from the own vehicle lane 51 to the adjacent lane 52. Note that, in this case, the running control unit 15 functions as lane change determination unit.

When it is determined in step S11 that the preconditions are satisfied, the process proceeds to step S12 to determine whether there exists the preceding vehicle 41 followed by the own vehicle 40. When it is determined that there exists the preceding vehicle 41, the process proceeds to step S13 to execute a first interlocking control. On the other hand, when it is not determined that there exists the preceding vehicle 41, that is, when it is determined that the own vehicle 40 is running at the set velocity or the own vehicle 40 is accelerated or decelerated to the set velocity, the process proceeds to step S14 to execute a second interlocking control.

Next, a procedure for the first interlocking control will be described with reference to the flowchart of FIG. 7. Referring to FIG. 7, it is determined in step S21 whether there exists the adjacent vehicle 42 in front of the own vehicle 40 in the direction indicated by the turn signal of the own vehicle 40. When there is no adjacent vehicle 42, a negative determination is made in step S21 and the process proceeds to step S25 to accelerate the own vehicle 40. The own vehicle 40 is accelerated by temporarily shortening the target inter-vehicle distance or the target inter-vehicle time. When the own vehicle 40 is being decelerated during the operation of the turn signal, the deceleration rate at that time is maintained.

When the adjacent vehicle 42 exists in front of the own vehicle 40 in the direction indicated by the turn signal of the own vehicle 40, an affirmative determination is made in step S21 and the process proceeds to step S22 to determine whether the relative speed W of the adjacent vehicle 42 to the own vehicle 40 is negative. When the relative velocity W is positive, the process proceeds to step S25 to start the acceleration of the own vehicle 40.

When the relative velocity W is negative, the process proceeds to step S23 to determine whether the own vehicle 40 before the switch-on of the turn signal was being accelerated.

When the own vehicle 40 was not being accelerated, that is, when the own vehicle 40 was running at a constant velocity or was being decelerated before the switch-on of the turn signal, the process proceeds to step S26 to maintain the running state of the own vehicle 40 before switch-on of the turn signal. That is, when the own vehicle 40 was running at a constant velocity, the constant-velocity running is maintained while the target acceleration rate remains zero, and when the own vehicle 40 was being decelerated, the deceleration is maintained while the target acceleration rate remains negative. In this case, the own vehicle 40 is not accelerated interlocking with the switch-on of the turn signal.

On the other hand, when the own vehicle 40 was being accelerated before the switch-on of the turn signal, the process proceeds to step S24 to set the distance lower limit value DL and the distance upper limit value DH of the acceleration suppression range based on the relative velocity W of the adjacent vehicle 42 to the own vehicle 40. In the present embodiment, a table illustrated in FIG. 5 is stored in advance in the recording medium. The running control unit 15 reads the distance lower limit value DL and the distance upper limit value DH according to the relative velocity W. The running control unit 15 also determines whether the relative distance D of the adjacent vehicle 42 to the own vehicle 40 is within the acceleration suppression range. When the relative distance D is shorter or longer, i.e., outside the acceleration suppression range, the process proceeds to step S26. In this case, the acceleration rate of the own vehicle 40 before the switch-on of the turn signal is maintained. On the other hand, when the relative distance D is within the acceleration suppression range, the process proceeds to step S27 to set the target acceleration rate of the own vehicle 40 to zero. Accordingly, the own vehicle 40 is suppressed from accelerating.

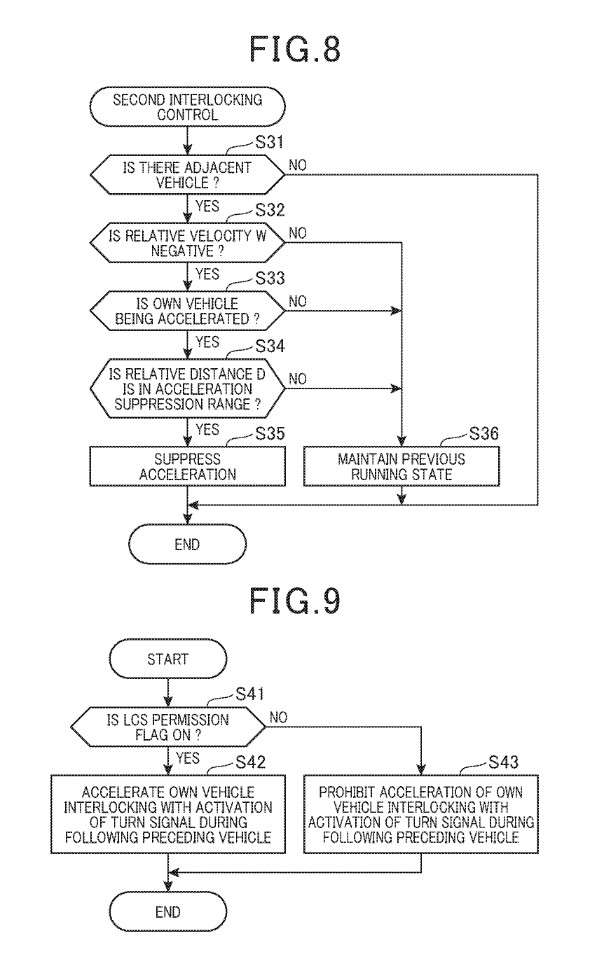

Next, a procedure for the second interlocking control will be described with the flowchart of FIG. 8. Referring to FIG. 8, it is determined in step S31 whether the adjacent vehicle 42 exists in front of the own vehicle 40 in the direction indicated by the turn signal of the own vehicle 40. When the adjacent vehicle 42 exists, the process proceeds to step S32 to determine whether the relative velocity W of the adjacent vehicle 42 to the own vehicle 40 is negative. When the relative velocity W is positive, the process proceeds to step S36 to maintain the running state of the own vehicle 40 immediately before the switch-on of the turn signal.

On the other hand, when the relative velocity W is negative, the process proceeds to step S33 to determine whether the own vehicle 40 was being accelerated before the switch-on of the turn signal. When the own vehicle 40 was not being accelerated, that is, when the own vehicle 40 was running at a constant velocity or being decelerated, the process proceeds to step S36 to maintain the running state of the own vehicle 40 before the switch-on of the turn signal.

When the own vehicle 40 was being accelerated before the switch-on of the turn signal, an affirmative determination is made in step S33, and the process proceeds to step S34 to set the distance lower limit value DL and the distance upper limit value DH of the acceleration suppression range based on the relative velocity W and determine whether the relative distance D is within the acceleration suppression range. When the relative distance D is shorter or longer, i.e., outside the acceleration suppression range, the process proceeds to step S36. In this case, the acceleration rate of the own vehicle 40 before the switch-on of the turn signal is maintained. On the other hand, when the relative distance D is within the acceleration suppression range, the process proceeds to step S35 to set the target acceleration rate of the own vehicle 40 to zero.

Accordingly, the own vehicle 40 is suppressed from accelerating.

According to the present embodiment described above in detail, the following advantageous effects can be obtained:

When the own vehicle 40 is accelerated along with the operation of the turn signal of the own vehicle 40, it may be necessary to decelerate the own vehicle 40 immediately after the acceleration depending on the presence or absence of the adjacent vehicle 42 in front of the own vehicle 40 or the running condition of the adjacent vehicle 42. In light of the foregoing respects, when the turn signal of the own vehicle 40 is operated, the acceleration of the own vehicle 40 is controlled based on the information on the adjacent vehicle in front of the own vehicle 40. According to this configuration, the acceleration of the own vehicle 40 during the lane change can be controlled depending on the condition of the adjacent vehicle 42 to suppress an unnatural behavior such as deceleration immediately after the acceleration from occurring. As a result, the vehicle can behave in accordance with the driver's feelings.

When the turn signal of the own vehicle 40 is operated when following the preceding vehicle 41 and there is no adjacent vehicle 42 in front of the own vehicle 40 at the time of the operation, the own vehicle 40 is accelerated interlocking with the operation of the turn signal, and when the turn signal of the own vehicle 40 is operated when following the preceding vehicle 41 and the adjacent vehicle 42 exists in front of the own vehicle 40 at the time of the operation, the own vehicle 40 is not accelerated interlocking with the operation of the turn signal. According to this configuration, in a scenario in which, after making a lane change, the own vehicle 40 will follow the fast-running adjacent vehicle 42, the own vehicle 40 is accelerated to implement a smooth lane change. In addition, in a scenario in which, after making a lane change, the own vehicle 40 will be decelerated due to the presence of the slow-running adjacent vehicle 42, the own vehicle 40 is kept from acceleration to suppress an unnatural behavior such as decelerating immediately after acceleration from occurring.

Even though the turn signal of the own vehicle 40 is operated when following the preceding vehicle 41, when the adjacent vehicle 42 exist in front of the own vehicle 40 at the time of the operation but the adjacent vehicle 42 is running faster than the own vehicle 40, the own vehicle 40 is accelerated interlocking with the operation of the turn signal. According to this configuration, in a scenario in which, after making a lane change, the own vehicle 40 will follow the fast-running adjacent vehicle 42, the own vehicle 40 is accelerated to perform a smooth lane change and start a smooth follow-up to the next preceding vehicle 41.

In the case where the turn signal of the own vehicle 40 is operated during acceleration of the own vehicle 40, when the adjacent vehicle 42 exists in front of the own vehicle 40 during the operation and the adjacent vehicle 42 is running slower than the own vehicle 40, the own vehicle 40 is suppressed from accelerating. Making a lane change while maintaining the acceleration might cause the need to decelerate the own vehicle 40 after the lane change. With consideration given to this point, according to the foregoing configuration, it is possible to suppress a scenario in which the own vehicle 40 is decelerated immediately after a lane change from occurring.

Even when the adjacent vehicle 42 slower than the own vehicle 40 exists in front of the own vehicle 40, when the adjacent vehicle 42 is distant from the own vehicle 40, no difference would be made depending on whether the own vehicle 40 is suppressed from accelerating or not. When the adjacent vehicle 42 is too close to the own vehicle 40, even when the own vehicle 40 is suppressed from accelerating, the own vehicle 40 may enter behind the adjacent vehicle 42 and perform no safe lane change. In light of these respects, it is determined whether to suppress the acceleration when the own vehicle 40 is being accelerated depending on the relative distance D of the adjacent vehicle 42 to the own vehicle 40. According to this configuration, it is possible to prevent acceleration of the own vehicle 40 from being unnecessarily suppressed.

In the case where the turn signal of the own vehicle 40 is operated in the absence of the preceding vehicle 41, when the adjacent vehicle 42 exists in front of the own vehicle 40 during the operation and the adjacent vehicle 42 is running faster than the own vehicle 40, the acceleration state before the operation of the turn signal of the own vehicle 40 (acceleration, deceleration, or no acceleration) is maintained. When the adjacent vehicle 42 is running faster than the own vehicle 40, the own vehicle 40 is unlikely to encounter a situation where the own vehicle 40 needs to be decelerated immediately after a lane change. Therefore, according to this configuration, it is possible to prevent an unnatural behavior of the own vehicle that would cause the driver a feeling of strangeness from occurring.

Preconditions for the turn-signal interlocking control include that a lane change from the own vehicle lane 51 to the adjacent lane 52 is permitted by the LCS function. Accordingly, when it is determined that the lane change from the own vehicle lane 51 to the adjacent lane 52 is permitted by the LCS function, the own vehicle 40 is accelerated interlocking with the operation of the turn signal when following the preceding vehicle 41, and when it is not determined that the lane change from the own vehicle lane 51 to the adjacent lane 52 is permitted by the LCS function, the own vehicle 40 is not accelerated interlocking with the operation of the turn signal when following the preceding vehicle 41. When the own vehicle 40 is accelerated in a situation where the lane change to the adjacent lane 52 is restricted by the LCS function, there may arise the need to stop the acceleration immediately afterward or decelerate the own vehicle 40. Therefore, in a situation where a control in cooperation with the LCS function is performed to restrict the lane change to the adjacent lane 52, the own vehicle 40 is not accelerated from the beginning even when the turn signal is operated, thereby preventing unnecessary acceleration.

### Second Embodiment

Next, a second embodiment will be described mainly focusing on the differences from the first embodiment. In the first embodiment, when the turn signal of the own vehicle 40 is operated when following the preceding vehicle 41, the acceleration of the own vehicle 40 is controlled based on the adjacent vehicle information. In the present embodiment, when the turn signal of the own vehicle 40 is operated when following the preceding vehicle 41, the acceleration of the own vehicle 40 is controlled based on the result of the determination on whether a lane change from the own vehicle lane 51 to the adjacent lane 52 is permitted.

That is, in a situation where a lane change from the own vehicle lane 51 to the adjacent lane 52 is not permitted, when the own vehicle 40 is accelerated along with the operation of the turn signal of the own vehicle 40, the acceleration may be stopped immediately afterward or the own vehicle 40 may be decelerated. In such a case, there is a concern that the driver will have a feeling of discomfort to the unnatural behavior in which the acceleration state of the own vehicle 40 changes in a short time.

Thus, in the present embodiment, in the case where the turn signal of the own vehicle 40 is operated when following the preceding vehicle 41, when the lane change from the own vehicle lane 51 to the adjacent lane 52 is permitted, the acceleration of the own vehicle 40 is started along with the operation of the turn signal of the own vehicle 40, and when the lane change from the own vehicle lane 51 to the adjacent lane 52 is not permitted, the acceleration of the own vehicle 40 is not started along with the operation of the turn signal of the own vehicle 40. Accordingly, the vehicle can behave in accordance with the driver's feelings.

FIG. 9 is a flowchart of a procedure for a turn-signal interlocking control in the present embodiment. The turn-signal interlocking control described in FIG. 9 is executed by the vehicle control device 10 upon acceptance of an input of a detection signal indicating that the turn signal is switched from off to on during the running of the own vehicle 40.

With reference to FIG. 9, it is determined in step S41 whether the lane change from the own vehicle lane 51 to the adjacent lane 52 is permitted by the LCS function. In this case, the LCS permission flag is inputted and it is determined whether the LCS permission flag is on. When the LCS permission flag is on, the process proceeds to step S42 to accelerate the own vehicle 40 interlocking with the operation of the turn signal when following the preceding vehicle 41. That is, when the turn signal of the own vehicle 40 is operated when following the preceding vehicle 41, the acceleration of the own vehicle 40 is started before the start of the lane change interlocking with the operation of the turn signal. On the other hand, when the LCS permission flag is off, the process proceeds to step S43 to prohibit the acceleration of the own vehicle 40 interlocking with the operation of the turn signal when following the preceding vehicle 41. In this case, even when the turn signal of the own vehicle 40 is operated when following the preceding vehicle 41, the acceleration of the own vehicle 40 is not started. Then, the process is terminated.

### OTHER EMBODIMENTS

The present disclosure is not limited to the foregoing embodiments but may be carried out in manners as described below, for example.

In the first embodiment, in the case where the turn signal of the own vehicle 40 is switched on when following the preceding vehicle 41, when the relative velocity W of the adjacent vehicle 42 to the own vehicle 40 is positive, the own vehicle 40 is accelerated. Alternatively, when the relative velocity W is larger than a positive velocity determination value, the own vehicle 40 may be accelerated. Specifically, when a negative determination is made in step S22 described in FIG. 7, it is determined whether the relative velocity W is higher than the positive velocity determination value (for example, several km/h to several tens of km/h). When an affirmative determination is made, step S25 is executed.

In the first embodiment, in the case where the own vehicle 40 is being accelerated when the turn signal of the own vehicle 40 is operated when following the preceding vehicle 41, the target acceleration rate is kept to maintain the acceleration before the operation of the turn signal. Alternatively, the target acceleration rate may be increased along with the operation of the turn signal of the own vehicle 40 when following the preceding vehicle 41 to further accelerate the own vehicle 40.

In the first embodiment, when the own vehicle 40 is following the preceding vehicle 41, the first interlocking control is executed, and when the own vehicle 40 is not following the preceding vehicle 41, the second interlocking control is executed. Alternatively, only either one of the controls may be executed. Specifically, when the own vehicle 40 is following the preceding vehicle 41, the first interlocking control may be executed, and when the own vehicle 40 is not following the preceding vehicle 41, the same control (for example, maintaining the running state before the operation of the turn signal) may be performed regardless of the presence or absence of the adjacent vehicle 42 or the relative velocity W.

In the first embodiment, among the adjacent vehicle information, the information on the presence or absence of the adjacent vehicle 42 and the relative velocity W of the adjacent vehicle 42 to the own vehicle 40 are used to control the acceleration of the own vehicle 40 interlocking with the operation of the turn signal of the own vehicle 40. Alternatively, the acceleration may be controlled by using only the information on the presence or absence of the adjacent vehicle 42. That is, when it is determined that the adjacent vehicle exists, the own vehicle 40 may not be accelerated interlocking with the operation of the turn signal regardless of the relative velocity W of the adjacent vehicle 42 to the own vehicle 40.

In the first embodiment, the preconditions include that the velocity of the own vehicle is equal to or less than the threshold Vth and that a lane change from the own vehicle lane to the adjacent lane is permitted by the LCS function. Alternatively, one of these preconditions may not be included. In addition, any conditions other than the foregoing ones may be further included.

In the foregoing embodiments, the adjacent vehicles are selected on the right lane and the left lane with respect to the own vehicle. Alternatively, the adjacent vehicle may be selected from only one of the right and left lanes. For example, when it is prohibited by law to pass a preceding vehicle from the left side, the adjacent vehicle may be selected from only the right lane with respect to the own vehicle.

In relation to the foregoing embodiments, the system including the radar device 22 as a distance measurement device has been described above. However, the present invention is not limited to this but an arbitrary distance measurement device such as a locator or a rider, for example, can be used. Alternatively, the radar device 22 may not be provided but the imaging device 21 may have the function of the distance measurement device. In this case, the imaging device 21 is preferably a compound eye camera such as a stereo camera.

The constituent elements described above are conceptual ones and are not limited to the ones in the foregoing embodiments. For example, the function of one constituent element may be distributed among a plurality of constituent elements or the functions of a plurality of constituent elements may be implemented by one constituent element.

The present disclosure has been described so far according to the embodiments, but it is noted that the present disclosure is not limited to the foregoing embodiments or structures. The present disclosure includes various modifications and changes in a range of equivalency. In addition, various combinations and modes, and other combinations and modes including only one element of the foregoing combinations and modes, less or more than the one element fall within the scope and conceptual range of the present disclosure.

1. A vehicle control device wherein,
when a turn signal of an own vehicle is operated when following a preceding vehicle, the vehicle control device performs a preceding vehicle following control to accelerate the own vehicle interlocking with an operation of the turn signal, the vehicle control device comprising:
an adjacent vehicle information acquisition unit that acquires adjacent vehicle information as information on an adjacent vehicle running in front of the own vehicle in an adjacent lane adjacent to a running lane of the own vehicle; and
an acceleration control unit that controls acceleration of the own vehicle based on the adjacent vehicle information when the turn signal of the own vehicle is operated.

2. The vehicle control device according to claim 1, wherein
the adjacent vehicle information includes information on the presence or absence of the adjacent vehicle, and
when a turn signal of the own vehicle is operated during the following of the preceding vehicle and no adjacent vehicle exists in front of the own vehicle during the operation of the turn signal, the acceleration control unit accelerates the own vehicle under the preceding vehicle following control, and when the turn signal of the own vehicle is operated during the following of the preceding vehicle and the adjacent vehicle exists in front of the own vehicle during the operation of the turn signal, the acceleration control unit does not accelerate the own vehicle under the preceding vehicle following control.

3. The vehicle control device according to claim 2, wherein
the adjacent vehicle information further includes information on a relative velocity of the adjacent vehicle to the own vehicle, and
even when the turn signal of the own vehicle is operated during the following of the preceding vehicle and the adjacent vehicle exists in front of the own vehicle during the operation of the turn signal, when the adjacent vehicle is running faster than the own vehicle, the acceleration control unit accelerates the own vehicle under the preceding vehicle following control.

4. The vehicle control device according to claim 1, wherein
the adjacent vehicle information includes information on the presence or absence of the adjacent vehicle and the relative velocity of the adjacent vehicle to the own vehicle, and
in a case where the turn signal of the own vehicle is operated during the acceleration of the own vehicle, when the adjacent vehicle exists in front of the own vehicle during the operation of the turn signal and the adjacent vehicle is running slower than the own vehicle, the acceleration control unit performs an acceleration suppression control to suppress the own vehicle from accelerating.

5. The vehicle control device according to claim 4, wherein
the acceleration control unit suppresses the own vehicle from accelerating under the acceleration suppression control according to the relative distance of the adjacent vehicle to the own vehicle.

6. The vehicle control device according to claim 1, wherein
the adjacent vehicle information includes information on the presence or absence of the adjacent vehicle and the relative velocity of the adjacent vehicle to the own vehicle, and
in a case where the turn signal of the own vehicle is operated in the absence of the preceding vehicle, when the adjacent vehicle exists in front of the own vehicle during the operation of the turn signal and the adjacent vehicle is running faster than the own vehicle, the acceleration control unit maintains an acceleration state that existed before the operation of the turn signal of the own vehicle.

7. The vehicle control device according to claim 1, further comprising:
a lane change determination unit that determines whether a lane change from a running lane of the own vehicle to the adjacent lane is permitted, wherein
when it is determined that the lane change is permitted by the lane change determination unit, the acceleration control unit accelerates the own vehicle under the preceding vehicle following control, and when it is not determined that the lane change is permitted by the lane change determination unit, the acceleration control unit does not accelerate the own vehicle under the preceding vehicle following control.

8. A vehicle control device, wherein
when a turn signal of an own vehicle is operated when following a preceding vehicle, the vehicle control device performs a preceding vehicle following control to accelerate the own vehicle interlocking with the operation, comprising:
a lane change determination unit that determines whether a lane change from a running lane of the own vehicle to an adjacent lane next to the running lane is permitted; and
an acceleration control unit that, when it is determined that the lane change is permitted by the lane change determination unit, accelerates the own vehicle under the preceding vehicle following control, and when it is not determined that the lane change is permitted by the lane change determination unit, does not accelerate the own vehicle under the preceding vehicle following control.

9. A vehicle control method for, when a turn signal of an own vehicle is operated when following a preceding vehicle, performing a preceding vehicle following control to accelerate the own vehicle interlocking with the operation of the turn signal, the method comprising:
acquiring adjacent vehicle information as information on an adjacent vehicle running in front of the own vehicle in an adjacent lane next to a running lane of the own vehicle; and
controlling acceleration of the own vehicle based on the adjacent vehicle information when the turn signal of the own vehicle is operated.

10. A vehicle control method for, when a turn signal of an own vehicle is operated when following a preceding vehicle, performing a preceding vehicle following control to accelerate the own vehicle interlocking with the operation of the turn signal, the method comprising:
determining whether a lane change from a running lane of the own vehicle to an adjacent lane next to the running lane is permitted; and
accelerating the own vehicle under the preceding vehicle following control when it is determined that the lane change is permitted by the lane change determination unit, and not accelerating the own vehicle under the preceding vehicle following control when it is not determined that the lane change is permitted by the lane change determination unit.
